(19) United States
(12) Patent Application Publication
(10) Pub. No.: US 2013/0057655 A1
(43) Pub. Date: Mar. 7, 2013

(54) IMAGE PROCESSING SYSTEM AND AUTOMATIC FOCUSING METHOD

(71) Applicants: Wen-Yueh SU, Taoyuan County (TW); Chun-Ta LIN, Taoyuan County (TW)

(72) Inventors: Wen-Yueh SU, Taoyuan County (TW); Chun-Ta LIN, Taoyuan County (TW)

(21) Appl. No.: 13/224,364

(22) Filed: Sep. 2, 2011

(51) Int. Cl. H04N 13/02

(52) U.S. Cl. 348/47; 348/E13.074

(57) ABSTRACT

The invention provides an image processing system. In one embodiment, the image processing system comprises a first camera, a second camera, a depth map generator, and an automatic focusing module. The first camera generates a first image. The second camera generates a second image. The depth map generator generates a depth map comprising information about visual shift between the first image and the second image. The automatic focusing module estimates a distance between a target object and a center position between the first camera and the second camera, and adjusts the focusing lengths of the first camera and the second camera according to the estimated distance.

### FIELD OF THE INVENTION

The invention relates to image processing, and more particularly to automatic focusing of images.

### BACKGROUND

When a camera takes a picture, the focusing length of the camera must be adjusted to make an incident light to be focused on a sensor of the camera. The adjusting process of the focus length is referred to as a focusing process. To make an image to have a high accuracy, the focusing process must precisely focus an incident light on a sensor component of the camera. The focusing process therefore must gradually adjust the focus length and is therefore a time-consuming process.

Ordinary digital cameras have an auto focusing function. A general auto focus function gradually moves a position of a lens to adjust a focus length, and then determines whether clarity of an image projected on a sensor meets a criterion. If the clarity of the image does not meet the criterion, the digital camera again adjusts the position of the lens. The auto focusing function moves the lens with a stepping motor, and the moving of the lens requires a long time period, resulting in a long delay period and degrading performance of the auto focusing function. If the delay is shortened, the performance of the auto focusing function is improved. An auto focusing method is therefore required.

### BRIEF SUMMARY OF THE INVENTION

The invention provides an image processing system. In one embodiment, the image processing system comprises a first camera, a second camera, and an image processing device. The first camera photographs an area to generate a first image. The second camera takes a picture of the area to generate a second image, wherein a parallax exists between the first image and the second image. The image processing device comprises a depth map generator and an auto focusing module. The auto focusing module adjusts the focus of the first camera and the second camera according to the parallax.

The invention further comprises an automatic focusing method. In one embodiment, an image processing system comprises a first camera, a second camera, and an auto focusing module. First, an area is photographed by the first camera to generate a first image. The area is photographed by the second camera to generate a second image, wherein a parallax exists between the first image and the second image. Focus lengths of the first camera and the second camera are then adjusted by the auto focusing module according to the parallax.

The following description is of the best-contemplated mode of carrying out the invention. This description is made for the purpose of illustrating the general principles of the invention and should not be taken in a limiting sense. The scope of the invention is best determined by reference to the appended claims:

### DETAILED DESCRIPTION OF THE INVENTION

Referring to FIG. 1, a block diagram of an image processing system 100 according to the invention is shown. In one embodiment, the image processing system 100 comprises two cameras 102 and 104 and an image processing device 106. The image processing device 106 comprises a synchronizing module 112, an adjusting module 114, an image processor 110, and an auto focusing module 118. In one embodiment, the image processor 110 further comprises a depth map generator 116. The cameras 102 and 104 are coupled to the image processing device 106. The camera 102 photographs an area to generate a first image. The camera 104 photographs the area to generate a second image. In one embodiment, the camera 102 generates the first image with a focus length different from that of the second image generated by the camera 104. In one embodiment, the cameras 102 and 104 are put in parallel, and the cameras 102 and 104 generate a 3D figure or a 3D video for a target object. A synchronizing module 112 synchronizes image generation of the cameras 102 and 104, and combines the first image with the second image to generate a joint image. The adjusting module 114 adjusts the joint image by filtering off image distortion between the first image and the second image to generate an adjusted image. The image processor 110 then processes the adjusted image.

The depth map generator 116 generates a depth map according to parallax between the first image and the second image. There is a parallax between the first image and the second image because the first camera 102 has a different position from that of the second camera 104. The depth map generator 116 then converts the parallax between the first image and the second image into parallax information corresponding to each pixel of the joint image, and further converts the parallax information into distance information corresponding to each pixel of the joint image. In one embodiment, the camera 102 is put towards the same direction as that of the camera 104, and the distance between the cameras 102 and 104 is fixed. Because the distance between the cameras 102 and 104 is fixed, there is a difference between the location of a target object in the first image and the location of the target object in the second image, and the difference is referred to as “visual difference” or “parallax”. The depth map generated by the depth map generator 116 therefore comprises parallax between the first image and the second image.

In one embodiment, the depth map generator 116 selects a target object from the first image and the second image, and determines the parallax of the target object according to a difference between locations of the target object in the first image and the second image. Because the parallax of the target object inversely changes with the distance between the target object and the image processing system 100, the depth map generator 116 then estimates the distance between the target object and the image processing system 100 according to the parallax of the target object. The depth map generator 116 then generates a depth map according to the parallax, wherein the depth map comprises a distance between the target object and the image processing system 100 in the area. In one embodiment, the depth map generator 116 further determines values of focus lengths of the cameras 102 and 104 according to the parallax of the target object in the depth map.

The depth map generated by the depth map generator 116 is then sent to the auto focusing module 118. The auto focusing module 118 then adjusts the focus lengths of the cameras 102 and 104 according to parallax information of the depth map; thereby making the image of the target object focused on the sensors of the cameras 102 and 104. In one embodiment, the auto focusing module 118 comprises a stepping motor for adjusting the focus lengths of the cameras 102 and 104. In one embodiment, the auto focusing module 118 generates focusing control signals to adjust the focus lengths of the cameras 102 and 104. Because the auto focusing module 118 has determined the distance between the target object and the image processing system 100, the auto focusing module 118 directly sets the focus lengths of the cameras 102 and 104 according to the distance between the target object and the image processing system 100. The focusing process of the cameras 102 and 104 is therefore rapid without delays, and the performance of the image processing system 100 is therefore improved.

Referring to FIG. 2, a flowchart of an automatic focusing method 200 according to the invention is shown. First, the first camera 102 photographs an area to generate a first image (step 202). The second camera 104 then photographs the area to generate a second image (step 204). The depth map generator 116 then generates a depth map according to the first image and the second image (step 206), wherein the depth map comprises parallax information between the first image and the second image. The depth map generator 116 then estimates a distance between the target object and the image processing system 100 according to parallax information of the depth map (step 208). In one embodiment, when the parallax corresponding to the target object is great, the depth map generator 116 estimates a shorter distance between the target object and the image processing system 100. When the parallax corresponding to the target object is small, the depth map generator 116 estimates a longer distance between the target object and the image processing system 100.

Referring to FIG. 3A, a schematic diagram of a parallax corresponding to a target object with a shorter distance from the image processing system is shown. The target object 350 is on the central axis between the cameras 302 and 304. The target object 350 has a distance D₁ from the middle point between the cameras 302 and 304. The target object 350 also has a distance D₃ from the axis of the camera 304. The angle α₂ between the axis of the camera 304 and the target object 350 is therefore equal to tan⁻¹(D₃/D₁). Because the angle α₁ between the axis of the camera 302 and the target object 350 is also equal to tan⁻¹(D₃/D₁), the parallax angle corresponding to the target object 350 is equal to 2×tan⁻¹(D₃/D₁). Referring to FIG. 3B, a schematic diagram of a parallax corresponding to a target object with a longer distance from the image processing system is shown. The target object 352 is on the central axis between the cameras 302 and 304. The target object 352 has a long distance D₂ from the middle point between the cameras 302 and 304. The target object 352 also has a distance D₃ from the axis of the camera 304. Similarly, the parallax angle corresponding to the target object 352 is equal to 2×tan⁻¹(D₃/D₂). Because the distance D₂ shown in FIG. 3B is longer than the distance D₁ shown in FIG. 3A, the parallax angle 2×tan⁻¹(D₃/D₂) of the target object 352 shown in FIG. 3B is smaller than the parallax angle 2×tan⁻¹(D₃/D₁) of the target object 350 shown in FIG. 3A. Thus, when the parallax corresponding to the target object is great, the depth map generator 116 estimates a shorter distance between the target object and the image processing system 100. When the parallax corresponding to the target object is small, the depth map generator 116 estimates a longer distance between the target object and the image processing system 100.

After the depth map generator 116 estimates the distance of the target object according to the parallax information of the depth map, the auto focusing module 118 adjusts the focus lengths of the cameras 102 and 104 according to the estimated distance (step 210). Ordinarily, the cameras 102 and 104 have a zoom lens to adjust the location of the lens in the cameras 102 and 104 to change the focus lengths thereof. In one embodiment, the depth map generator 116 estimates values of focus lengths according to the estimated distance of the target object, and the auto focusing module 118, and then sends focusing control signals to the cameras 102 and 104 to adjust the focus lengths of the cameras 102 and 104. The image of the target object is therefore directly projected on the sensors of the cameras 102 and 104. Finally, the auto focusing module 118 then finely tunes the focus lengths of the cameras 102 and 104 to make the clarity of the first image and the second image to meet a criterion (step 212).

Referring to FIG. 4, a schematic diagram of selection of a target object from an image 400 according to the invention is shown. The image 400 may be the first image generated by the camera 102, the second image generated by the camera 104, the joint image generated by the synchronizing module 112, or the adjusted image generated by the adjusting module 114. First, the image processor 110 divides the image 400 into 9 regions 401, 402, 403, 404, 405, 406, 407, 408, and 409. The image processor 110 then searches a specific region selected from the regions 401˜409 for a target object. For example, the target object is a human face. Ordinarily, the middle region 405 is predetermined to be the specific region. The specific region may also be selected by a user. In one embodiment, the image processor 110 performs a face recognition process to search the specific region for the human face which is than determined to be the target object.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

### BRIEF DESCRIPTION OF THE DRAWINGS

FIG. 1 is a block diagram of an image processing system according to the invention;

FIG. 2 is a flowchart of an automatic focusing method according to the invention;

FIG. 3A is a schematic diagram of a parallax corresponding to a target object with a shorter distance from the image processing system;

FIG. 3B is a schematic diagram of a parallax corresponding to a target object with a longer distance from the image processing system; and

FIG. 4 is a schematic diagram of selection of a target object from an image according to the invention.

### DESCRIPTION OF SYMBOLS OF MAJOR COMPONENTS

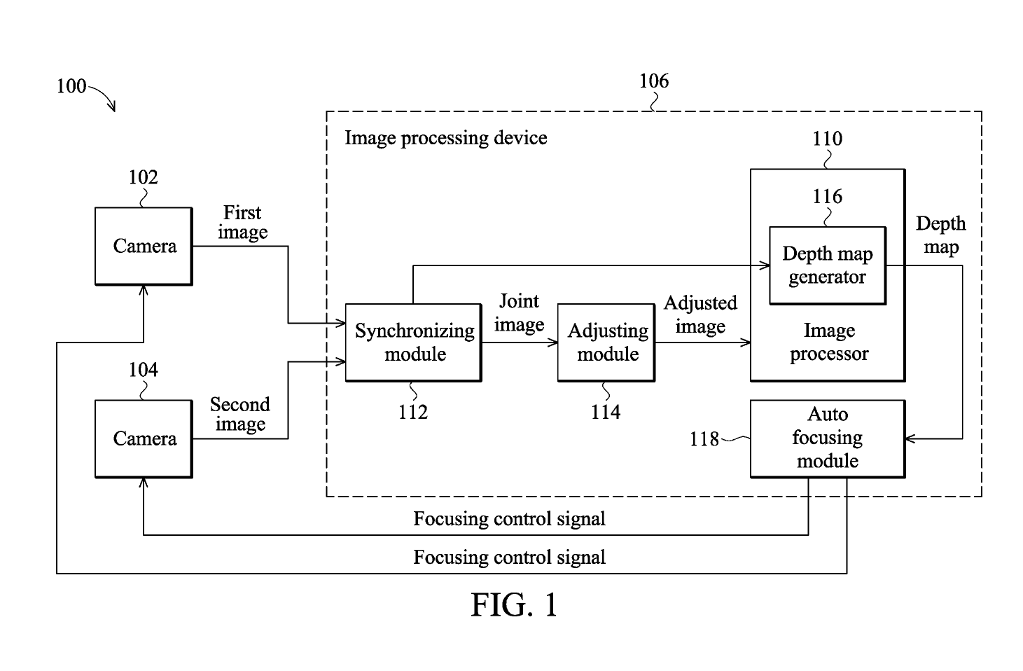

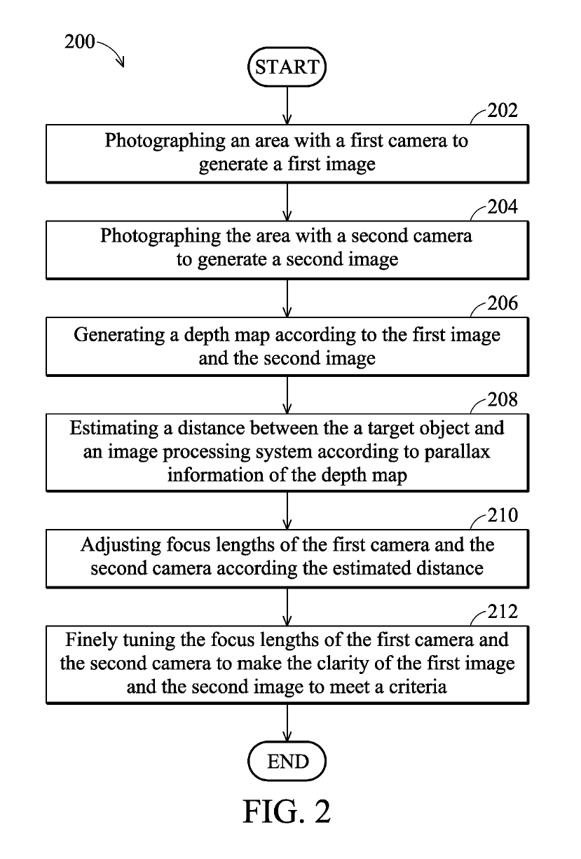

(FIG. 1)
100˜image processing system;
102, 104˜cameras;
106˜image processing device;
112˜synchronizing module;
114˜adjusting module;
116˜depth map generator;
110˜image processor;
118˜auto focusing module;

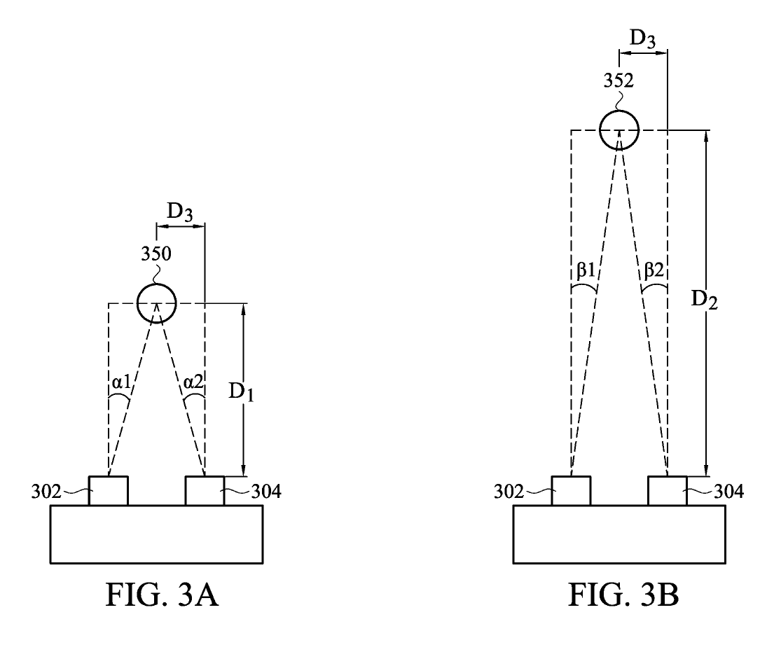

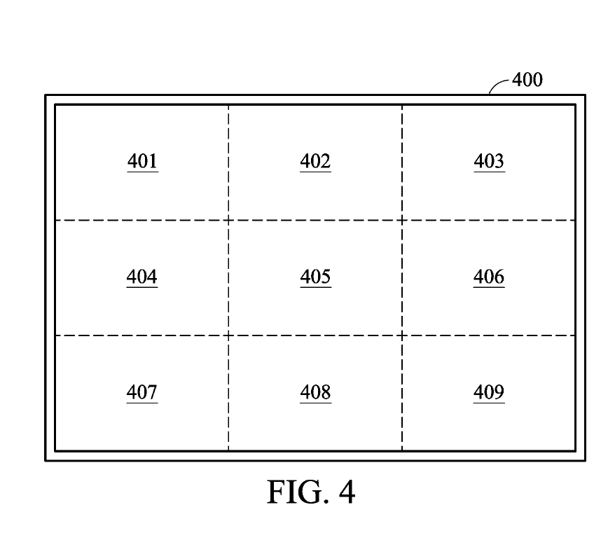

(FIG. 3A/FIG. 3B)
350, 352˜target object;
302, 304˜cameras.

What claimed is:

1. An image processing system, comprising:
a first camera, photographing an area to generate a first image;
a second camera, photographing the area to generate a second image, wherein a parallax exists between the first image and the second image; and
an image processing device, coupled to the first camera and the second camera, comprising:
a depth map generator; and
an auto focusing module, adjusting the focus of the first camera and the second camera according to the parallax.

2. The image processing system as claimed in claim 1, wherein the first camera and the second camera are put in parallel, and the first camera and the second camera generate a 3D figure or a 3D video for a target object.

3. The image processing system as claimed in claim 1, wherein the depth map generator generates a depth map according to the parallax, selects a target object from the first image and the second image, and estimates a distance between the target object and the image processing system according to the parallax of the target object in the depth map.

4. The image processing system as claimed in claim 1, wherein the depth map generator selects a target object from the first image and the second image, and determines the parallax of the target object according to a difference between locations of the target object in the first image and the second image.

5. The image processing system as claimed in claim 4, wherein the depth map generator generates a depth map according to the parallax, wherein the depth map comprises a distance between the target object and the image processing system in the area.

6. The image processing system as claimed in claim 5, wherein the depth map generator determines values of focus lengths of the first camera and the second camera according to the distance between the target object and the image processing system.

7. The image processing system as claimed in claim 6, wherein the auto focusing module adjusts the focus lengths of the first camera and the second camera according to the values of the focus lengths determined by the depth map generator.

8. The image processing system as claimed in claim 1, wherein the auto focusing module comprises a stepping motor for adjusting the focus lengths of the first camera and the second camera.

9. The image processing system as claimed in claim 1, wherein the auto focusing module further finely tunes the focus lengths of the first camera and the second camera until the clarity of the target object in the first image and the second image meets a criterion.

10. The image processing system as claimed in claim 5, wherein when the parallax corresponding to the target object is great, the target object shown in the depth map generated by the depth map generator has a shorter distance from the image processing system, and when the parallax corresponding to the target object is small, the target object shown in the depth map generated by the depth map generator has a longer distance from the image processing system.

11. The image processing system as claimed in claim 1, wherein the first camera is put towards the same direction as that of the second camera, and the distance between the first camera and the second camera is fixed.

12. The image processing system as claimed in claim 1, wherein the first image and the second image are divided into a plurality of image regions, and the target object is obtained by searching a specific region selected from the image regions, wherein the specific region is pre-determined or appointed by a user.

13. The image processing system as claimed in claim 1, wherein the image processing system comprises an image processor, the depth map generator is a component of the image processor, and the image processor generates a focusing control signal sent to the auto focusing module to adjust the focus lengths of the first camera and the second camera.

14. An automatic focusing method, wherein an image processing system comprises a first camera, a second camera, and an auto focusing module, the automatic focusing method comprises:
photographing an area with the first camera to generate a first image;
photographing the area with the second camera to generate a second image, wherein a parallax exists between the first image and the second image; and
adjusting the focus of the first camera and the second camera with the auto focusing module according to the parallax.

15. The automatic focusing method as claimed in claim 14, wherein the first camera and the second camera are put in parallel, and the first camera and the second camera generate a 3D figure or a 3D video for a target object.

16. The automatic focusing method as claimed in claim 14, wherein the image processing system further comprises a depth map generator, and the automatic focusing method further comprises:
selecting a target object from the first image and the second image with the depth map generator, and
determining the parallax according to a difference between locations of the target object in the first image and the second image with the depth map generator.

17. The automatic focusing method as claimed in claim 16, wherein the automatic focusing method further comprises:
generating a depth map according to the parallax with the depth map generator, wherein the depth map comprises a distance between the target object and the image processing system in the area.

18. The automatic focusing method as claimed in claim 17, wherein the automatic focusing method further comprises:
determining values of focus lengths of the first camera and the second camera according to the distance between the target object and the image processing system with the depth map generator.

19. The automatic focusing method as claimed in claim 18, wherein the automatic focusing method further comprises:
adjusting the focus lengths of the first camera and the second camera with the auto focusing module according to the values of the focus lengths determined by the depth map generator.

20. The automatic focusing method as claimed in claim 14, wherein the auto focusing module comprises a stepping motor for adjusting the focus lengths of the first camera and the second camera.

21. The automatic focusing method as claimed in claim 14, wherein the automatic focusing method further comprises:
finely tuning the focus lengths of the first camera and the second camera with the auto focusing module until the clarity of the target object in the first image and the second image meets a criterion.

22. The automatic focusing method as claimed in claim 17, wherein when the parallax corresponding to the target object is great, the target object shown in the depth map generated by the depth map generator has a shorter distance from the image processing system, and when the parallax corresponding to the target object is small, the target object shown in the depth map generated by the depth map generator has a longer distance from the image processing system.

23. The automatic focusing method as claimed in claim 14, wherein the first camera is put towards the same direction as that of the second camera, and the distance between the first camera and the second camera is fixed.

24. The automatic focusing method as claimed in claim 14, wherein the automatic focusing method further comprises:
dividing the first image and the second image into a plurality of image regions; and
searching a specific region selected from the image regions for the target object, wherein the specific region is pre-determined or appointed by a user.

25. The automatic focusing method as claimed in claim 14, wherein the image processing system comprises an image processor, the depth map generator is a component of the image processor, and the image processor generates a focusing control signal sent to the auto focusing module to adjust the focus lengths of the first camera and the second camera.
